(19) United States
(12) Patent Application Publication
(10) Pub. No.: US 2010/0045685 A1
(43) Pub. Date: Feb. 25, 2010

(54) Liquid Crystal Display Device

(75) Inventors: Toshiaki Suzuki, Kanagawa (JP); Kazuhiro Nukiyama, Kanagawa (JP); Hisashi Mamiya, Kanagawa (JP); Koichi Sono, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/583,315

(22) Filed: Aug. 18, 2009

(30) Foreign Application Priority Data
Aug. 21, 2008 (JP) P2008-212997

(51) Int. Cl. G09G 3/36; G06T 1/60; G09G 5/00

(52) U.S. Cl. 345/530; 345/211; 345/98

(57) ABSTRACT

A liquid crystal display device with shorter response time and simpler configuration is provided. The liquid crystal display device including: a plurality of pixels each including a liquid crystal element; and a driving section performing an image display driving by applying a driving voltage based on a video signal to the liquid crystal element in each of the pixels. The driving section performs an overdrive processing on the video signal of current frame to generate an overdriven video signal based on a current frame image and an immediately preceding frame image of the input images based on the video signals, and based on immediately-preceding-state information which is additional information briefly representing a immediately preceding state of the liquid crystal element of the pixel.

### BACKGROUND OF THE INVENTION

1. Field of the Invention

The present invention relates to a liquid crystal display device in which overdrive operation is carried out.

2. Description of the Related Art

In recent years, a liquid crystal display (LCD) device provided with a liquid crystal display has been developing drastically. For example, in the case of PC (personal computer), although the LCD device used therein has displayed a still picture in general on the screen in the past, recently it works as a graphic system displaying a dynamic image or works as a monitor displaying a video picture, and so on. Namely, LCD has been widely substituting for CRT (cathode ray tube) so that interest in the movie display technique for LCD is increasing rapidly.

A critical issue at the time of displaying dynamic images on the LCD is the slow response of liquid crystal. Namely, since residual image is seen when dynamic image is displayed on a display unit with slow response, display quality deteriorates.

Accordingly, what is called overdrive technique is proposed by, for example, Japanese Patent Application Publication No. 2005-107531 as one of the measures for improving the response time of LCD. The overdrive technique is a technique to accelerate the transition of luminance state by applying a voltage higher than the target voltage to a frame in which the first input change occurs for example, in order to improve the response characteristics to step inputs. With such overdrive technique, it becomes possible to improve the gray level response time of LCD devices.

In accordance with the response characteristics based on the liquid crystal material or pixel structure, sometimes the overdrive processing is necessary to add an image of two or more frames backward.

Accordingly, some recent disclosure includes an LCD device in which the overdrive operation is performed with the use of a few immediately preceding frames.

### SUMMARY OF THE INVENTION

The way of the overdrive processing with the use of images of a few immediately preceding frames is illustrated in, for example, FIG. 12. Namely, as shown in the reference numeral P101 in the diagram, an overdriven output image fout(N) is generated in the overdrive processing section 102 based on an input image fin(N) in the current frame (frame “N”), the immediately preceding image fbuf1(N) (=fin(N−1)) in the immediately preceding frame (frame “N−1”), and an image fbuf2(N) (=fin(N−2)) of two frames backward (frame “N−2”).

However, such overdrive processing has a disadvantage of increase in frame memory as more frames are used for the overdrive processing because a whole image of two or more frames backward is directly used as it is.

A phenomenon called backflow may occur during a specific drive transition in the VA-mode LCD device including vertical alignment liquid crystal, for example, which disturbs improvement in the response characteristics. Specifically, for example, the reference numeral P200 in FIG. 13 represents a case in which overdrive driving is not applied and the reference numerals P201 to P203 represent cases in which the overdrive driving is applied using one to three frames, respectively. The figure illustrates that even though the response characteristics have improved in the reference numerals P201 to P203, the above-mentioned backflow phenomenon has occurred.

Thus, it is difficult for the overdrive technique of related art to effectively improve the response time with simple configuration.

It is desirable to provide an LCD device capable of improving response time with simple configuration.

According to an embodiment of the present invention, there is provided an LCD device including a plurality of pixels each including a liquid crystal element therein, and a driving section performing an image display driving by applying a driving voltage based on a video signal to the liquid crystal element in each of the pixels. The driving section performs an overdrive processing on the video signal of current frame to generate an overdriven video signal based on a current frame image and an immediately preceding frame image of the input images based on the video signals, and based on immediately-preceding-state information which is additional information briefly representing a immediately preceding state of the liquid crystal element of the pixel.

According to the LCD device of an embodiment of the present invention, the overdrive processing is performed on the video signal of current frame to generate the overdriven video signal based on the current frame image and the immediately preceding frame image of the input images based on the video signals, and based on immediately-preceding-state information which is additional information briefly representing a immediately preceding state of the liquid crystal element of the pixel. In other words, since the additional information including information of preceding frames previous to the immediately preceding frame is used, more effective overdrive processing is available than the case in which only the image in the immediately preceding frame is used. In addition, since the additional information is simplified, simpler configuration is available than the case of related art in which a whole image preceding two or more frames is used directly as it is.

According to the LCD device of an embodiment of the present invention, since the overdrive processing is performed on the video signal based on the current frame image, the immediately preceding frame image, and immediately-preceding-state information to generate the overdriven video signal, information including information of preceding frames previous to the immediately preceding frame is added. In addition, more effective overdrive processing is available with the use of the simplified additional information, and simpler configuration is available than ever. As a result, response time may be improved with simpler configuration than ever.

### BRIEF DESCRIPTION OF THE DRAWINGS

FIG. 1 is a block diagram illustrating a configuration of an LCD device according to an embodiment of the present invention.

FIGS. 2A and 2B are plan views illustrating an example of a detailed internal configuration of a pixel of FIG. 1.

FIG. 3 illustrates an exemplary cross-sectional configuration of the pixel of FIG. 2.

FIG. 4 is a block diagram illustrating the detailed configuration of an overdrive processing section of FIG. 1.

FIG. 5 illustrates an exemplary look-up table (LUT) used in the overdrive processing section of FIG. 4.

FIG. 6 is a figure to explain a fundamental configuration of additional information etc., which is used in the overdrive processing section.

FIGS. 7A and 7B are figures to explain exemplary configurations of the additional information etc., which is used in the overdrive processing section of FIG. 1.

FIG. 8 is a timing diagram to explain the overdrive processing.

FIG. 9 is a block diagram illustrating a detailed configuration of the overdrive processing section according to a modification of the present invention.

FIG. 10 is an exemplary configuration of the additional information etc., which is used in the overdrive processing section of FIG. 9.

FIGS. 11A and 11B are photo diagrams illustrating an example of how an in-pixel deviation look like.

FIG. 12 is a timing diagram to explain the overdrive processing of related art.

FIGS. 13A and 13B are timing waveforms to explain the overdrive processing of related art.

### DESCRIPTION OF THE PREFERRED EMBODIMENTS

Embodiments of the invention will be described in detail hereinbelow with reference to the drawings.

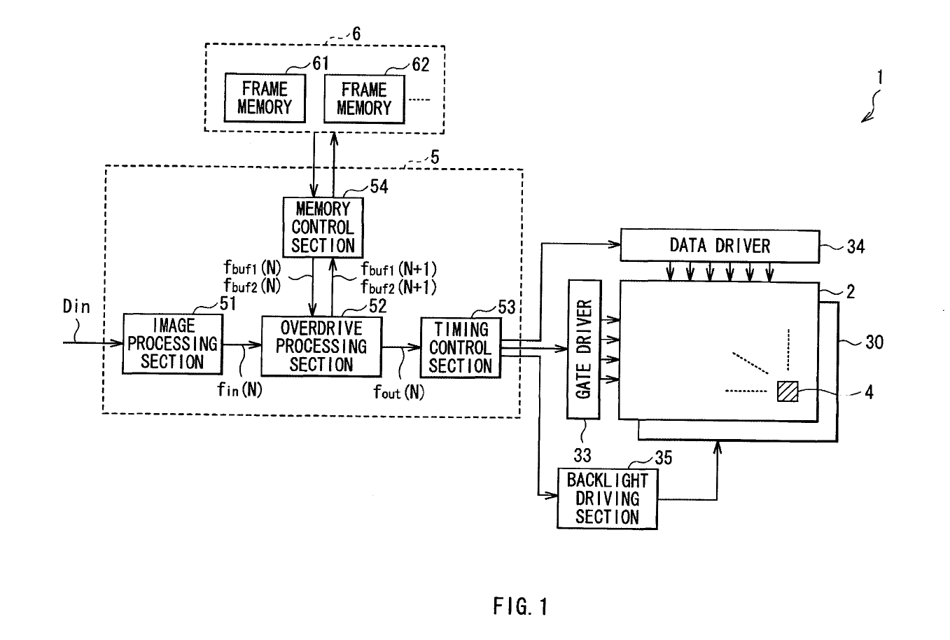

FIG. 1 illustrates an entire functional block of an LCD device (LCD device 1) according to an embodiment of the present invention. The LCD device 1 includes an LCD panel 2, a backlight section 30, a video signal processing section 5, a frame memory section 6, a gate driver 33, a data driver 34, and a backlight driving section 35.

The backlight section 30 is a light source illuminating the LCD panel 2, and is configured to include CCFL (cold cathode fluorescent lamp), LED (light emitting diode) or the like.

The LCD panel 2 modulates a light emitted from the backlight 30 based on a video signal transmitted from the data driver 34 in response to a driving signal supplied from the gate driver 33, and displays images on the screen. The LCD panel 2 is an active matrix LCD panel having a plurality of pixels 4 arranged in matrix, in which driving operation is performed separately for each of the plurality of pixels 4. The detailed configuration of the pixel 4 will be mentioned hereinbelow.

The video signal processing section 5 generates a video signal as an RGB signal carrying out a predetermined image processing to a video signal Din transmitted from outside. The video signal processing section 5 includes an image processing section 51, an overdrive processing section 52, a timing control section 53 and a memory control section 54.

The image processing section 51 generates an input image fin(N) of an RGB signal by applying a predetermined image processing (for example, white balance processing etc.) to the video signal Din transmitted from outside.

The overdrive processing section 52 generates an overdriven video signal (output image fout(N)) by applying the overdrive processing to the video signal of the input image fin(N), based on the input image fin(N) (image of the current frame (frame “N”)), a immediately preceding image fbuf1(N), which is an image of the immediately preceding frame (frame “N−1”), and additional information fbut2 (N), which is information expressed in brevity on the state of the liquid crystal elements of the respective pixels 4 in the immediately preceding frame. Further, the overdrive processing section 52 generates a immediately preceding image fbuf1(N+1) and additional information fbuf2 (N+1) corresponding to the current frame respectively, which are used upon applying an overdrive processing to the video signal of an input image fin (N+1) of the next frame (frame “N+1”), based on the input image fin(N), the immediately preceding image fbuf1(N), and the additional information fbuf2(N). The detailed configuration of the overdrive processing section 52 will be described hereinbelow.

The timing control section 53 generates a video signal supplied to the data driver 34 based on the output image fout supplied from the overdrive processing section 52, and generates a control signal (timing signal) for the gate driver 33, the data driver 34 and the backlight driving section 35.

The memory control section 54 exchanges data between the overdrive processing section 52 and the frame memory section 6, and controls reading and writing of data on the frame memory section 6 side. Specifically, the immediately preceding image fbuf1(N) and the additional information fbuf2(N) are supplied from the frame memory section 6 to the overdrive processing section 52, and the immediately preceding image fbuf1(N+1) and the additional information fbuf2 (N+1) are supplied from the overdrive processing section 52 to the frame memory section 6.

The frame memory section 6 stores the data supplied from the video signal processing section 5 (memory control section 54) separately based on each frame, and includes, for example, frame memories 61 and 62, etc.

The gate driver 33 line-sequentially drives the respective pixels 4 in the LCD panel 2 along a not-illustrated scan line (gate line) in accordance with the timing control executed by the timing control section 53. The data driver 34 supplies a driving voltage based on the video signal to the pixels 4 of the LCD panel 2, respectively.

The backlight driving section 35 controls the lighting operation of the backlight section 30 in accordance with the timing control of the timing control section 53.

The timing control section 53 controls the driving timing of the gate driver 33, the data driver 34 and the backlight driving section 35.

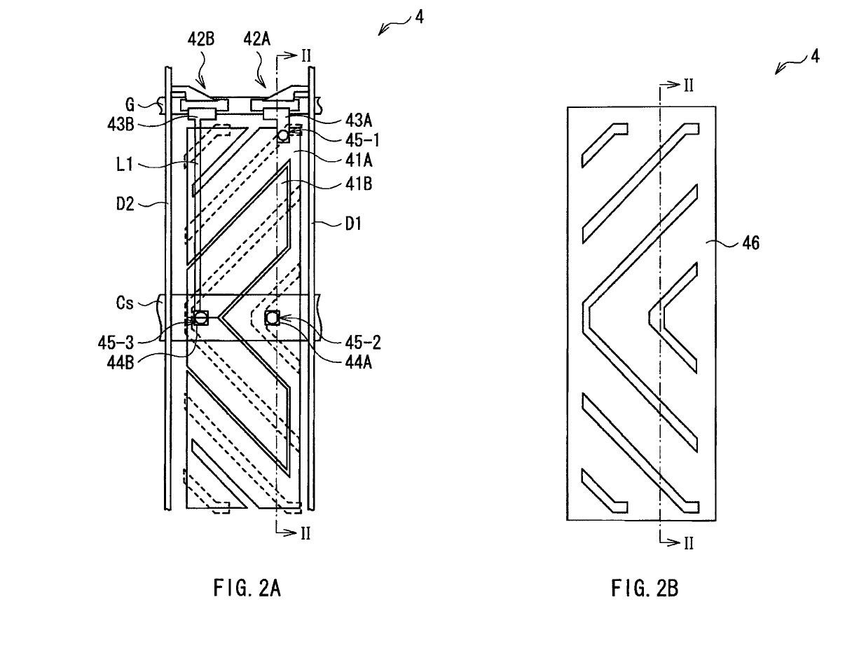

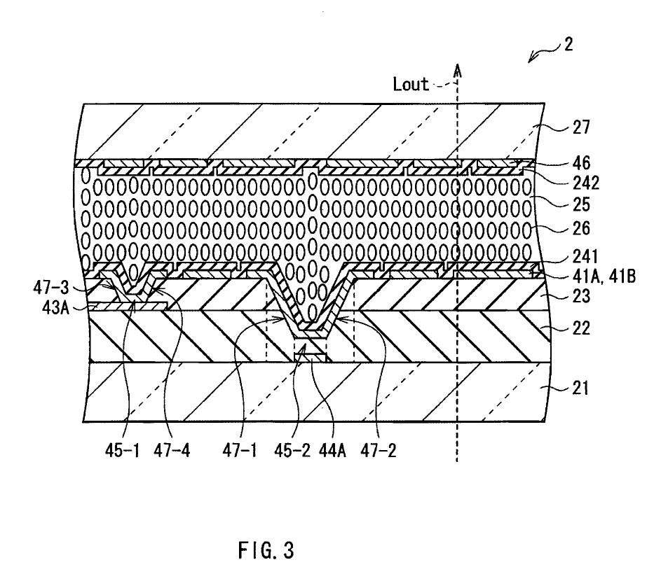

Subsequently, the detailed configuration of the pixel 4 will be explained with reference to FIGS. 2A, 2B and 3. FIGS. 2A and 2B are plan views illustrating an internal configuration of the pixel 4, and FIG. 2A is a plan view illustrating the configuration on an after-mentioned TFT substrate (TFT substrate 21) side and FIG. 2B is a plan view illustrating the configuration on an after-mentioned counter substrate (counter substrate 27) side. FIG. 3 is a cross sectional view taken along line II-II of FIGS. 2A and 2B as seen from the direction indicated by the arrows.

As illustrated in FIG. 2A, two transparent pixel electrodes 41A and 41B made of ITO (indium-tin oxide) etc., for example, are disposed on the respective pixels 4 on the TFT substrate side. Slits are formed in these pixel electrodes 41A and 41B to generate an oblique electric field and control the liquid crystal molecule director at the time of voltage application. In addition, TFT elements 42A and 42B are disposed corresponding to the pixel electrodes 41A and 41B, respectively. A gate line G and a data line D1 are connected to the TFT element 42A so that a voltage based on a video signal is applied to the pixel electrode 41A. Meanwhile, a gate line G and a data line D2 are connected to the TFT element 42B, and a voltage based on a video signal is applied to the pixel electrode 41B. On the auxiliary capacity line Cs, auxiliary capacity electrodes 44A and 44B are disposed corresponding to the pixel electrodes 41A and 41B, respectively to form auxiliary capacitance. The auxiliary capacity electrodes 44A and 44B and the pixel electrodes 41A and 41B are electrically connected by contact portions 45-2 and 45-3, respectively. The drain electrode 43A of the TFT element 42A and the pixel electrode 41A are electrically connected by a contact portion 45-1, and the drain electrode 43B of the TFT element 42B and the auxiliary capacity electrode 44B are electrically connected by a wiring L1.

Meanwhile, as illustrated in FIG. 2B, an opposite electrode 46 as a common electrode shared by the respective pixels 4 is disposed on the pixels 4 on the counter substrate side. The opposite electrode 46 is also a transparent electrode made of ITO, for example, and slits are formed therein to generate an oblique electric field so as to control the director of liquid crystal molecules at the time of voltage application as with the pixel electrodes 41A and 41B. However, the slits of the pixel electrode 41A and 41B and the slits of the opposite electrode 46 are located out of alignment so as not to face each other. With such a configuration, the oblique electric field is applied to the long axis of an after-mentioned liquid crystal molecule when the driving voltage is applied between the pixel electrodes 41A/41B and the opposite electrode 46. That improves not only the response time to voltage but also viewing angle characteristics because domains of different alignment are formed in the same pixel 4 (multiple alignment).

In the LCD panel 2, as illustrated in FIG. 3, a liquid crystal layer 25 including a liquid crystal molecule 26 is formed between the TFT substrate 21 and the counter substrate (CF (color filter) substrate) 27.

The TFT substrate 21 is made of a glass substrate, for example. The above-mentioned pixel electrodes 41A and 41B are disposed on the TFT substrate 21 with an insulating layer 22 and a planarization film 23 in between. In addition, the above-mentioned auxiliary capacity electrode 44A and the drain electrode 43A are disposed on the TFT substrate 21. The insulating layer 22 and the planarization film 23 have a depressed portion in the vicinity of contact portions 45-2 and 45-1, which are located between the auxiliary capacity electrodes 44A and the pixel electrode 41A and between the drain electrode 43A and the pixel electrode 41B, respectively. These depressed portions include inclined portions 47-1 and 47-2, and inclined portions 47-3 and 47-4, respectively. The depth (height) of the depressed portions are of the order of 1.0 μm on the auxiliary capacity electrode 44A side, and of the order of 0.6 μm on the drain electrode 43A side. The width of the inclined portions 47-1 and 47-2 and inclined portions 47-3 and 47-4 is of the order of 10 to 20 μm.

The counter substrate 27 is made of, for example, a glass substrate. On the counter substrate 27, the above-mentioned opposite electrode 46 and a color filter (not illustrated) in which two or more color filters such as red(R), green(G) and blue(B) are provided in a striped pattern are disposed.

Vertical alignment films 241 and 242 are formed on the pixel electrodes 41A and 41B disposed on the TFT substrate 21 side and on the opposite electrode 46 disposed on the counter substrate 27 side, respectively. These vertical alignment films 241 and 242 are made of an organic material such as polyimide, and function to align the liquid crystal molecules 26 in a direction perpendicular to the face of the substrates, respectively.

The liquid crystal layer 25 is configured to include a vertical alignment liquid crystal (VA-mode liquid crystal), such as, for example, the liquid crystal molecule 26 having a negative dielectric anisotropy. The liquid crystal molecule 26 has a characteristic that a dielectric constant of the short axis direction is larger than that of the long axis direction. Because of such a characteristic, the liquid crystal molecules 26 are aligned so that the long axis thereof may be perpendicular to the substrates when the driving voltage applied between the pixel electrodes 41A and 41B and the opposite electrode 46 is OFF, while the liquid crystal molecules 26 are aligned so that the long axis thereof may be in parallel to the substrates when the driving voltage is ON.

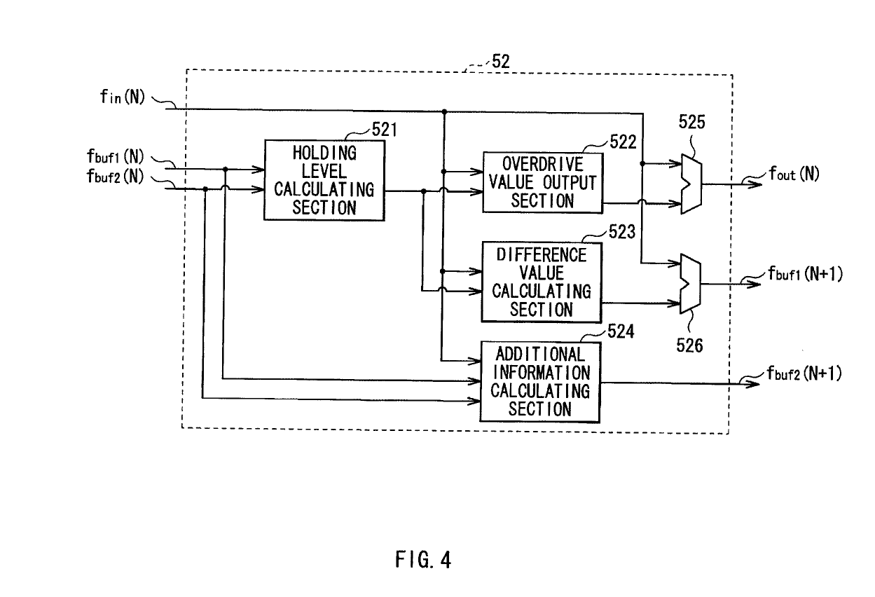

Subsequently, detailed configuration of the overdrive processing section 52 will be hereinbelow explained with reference to FIGS. 4 to 7A and 7B. FIG. 4 illustrates a block configuration of the overdrive processing section 52.

The overdrive processing section 52 includes a holding level calculating section 521, an overdrive value output section 522, a difference value calculating section 523, an additional information calculating section 524, and add/subtract sections 525 and 526.

The holding level calculating section 521 calculates a current state of the liquid crystal element (effectual voltage holding level) in the current frame based on the immediately preceding image fbuf1(N) and the additional information fbuf2(N).

The overdrive value computing section 522 calculates and outputs an overdrive value based on the current state of the liquid crystal element (effectual voltage holding level) in the current frame supplied from the holding level calculating section 521 and the input image fin(N). Specifically, the number of the frames and the overdrive value at the time of performing the overdrive processing are determined using a look-up table (LUT) as illustrated, for example, in FIG. 5.

The difference value calculating section 523 calculates a difference value of an image in the current frame (namely, the immediately preceding frame as viewed from the next frame) used when performing the overdrive processing for a video signal of an input image fin (N+1) in the next frame (frame “N+1”), based on the current state of the liquid crystal element (effectual voltage holding level) in the current frame supplied from the holding level calculation part 521 and the input image fin(N).

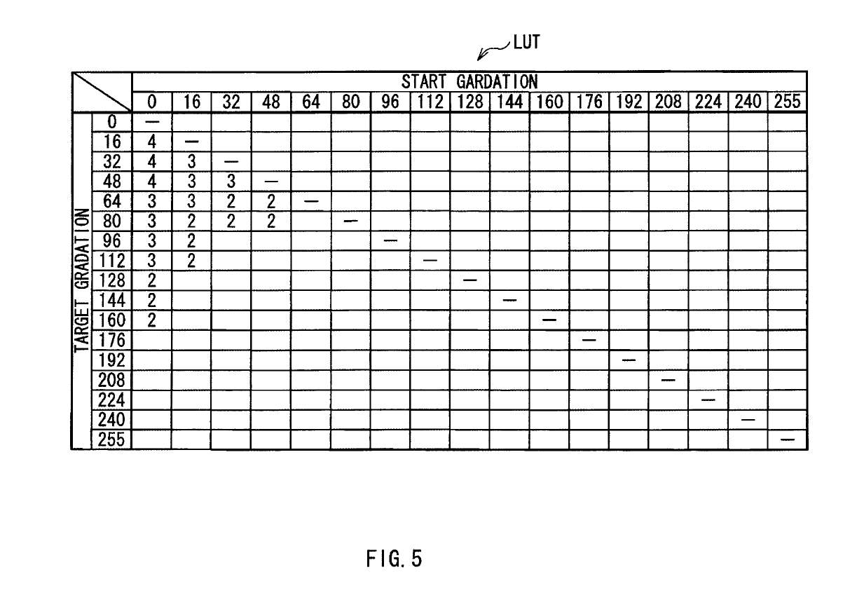

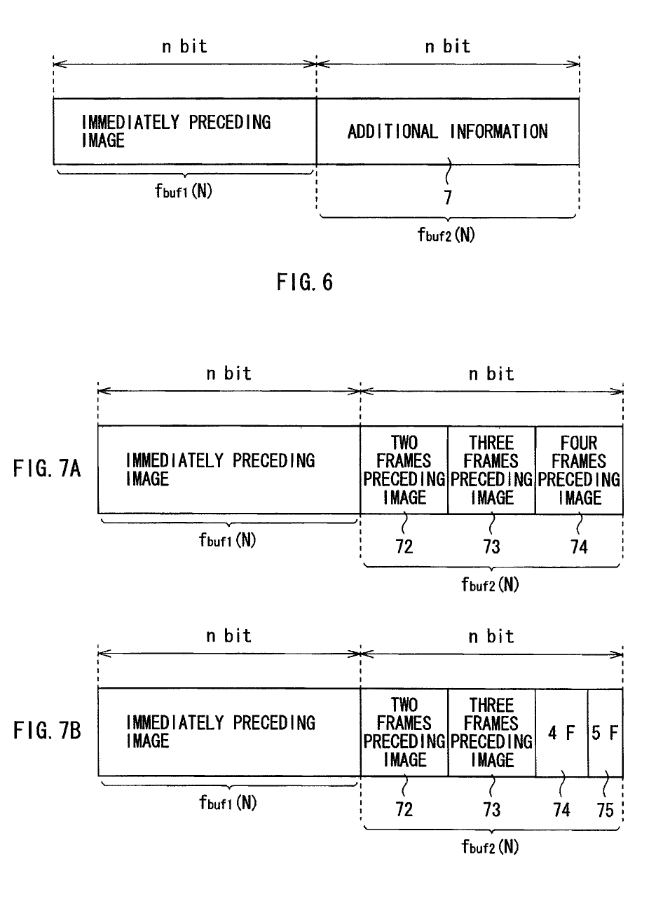

The additional information calculation section 524 generates additional information fbuf2 (N+1) corresponding to the current frame used when performing the overdrive processing for a video signal of an input image fin (N+1) in the next frame (frame “N+1”), based on the input image fin(N), the immediately preceding image fbuf1(N), and the additional information fbuf2(N). The additional information fbuf2(N) is information expressed in brevity on the current state of the liquid crystal elements of the respective pixels 4 in the immediately preceding frame as illustrated in the additional information 7 of FIG. 6, for example, of which amount is almost equal to that of the immediately preceding image fbuf1(N) (n=16 bits, for example).

Specifically, according to the present embodiment, compressed information, which is formed by compressing images of two or more frames backward from the current frame (here, an image 72 of two frames backward to an image 74 of four frames backward) as illustrated in FIG. 7A for example, is used as the additional information fbuf2(N). It is to be noted that, as illustrated in FIG. 7B for example, the amount of such information (bits) is weighted so that the information amount decreases as going backward from the current frame (here, as the frames go backward from an image 72 of two frames backward to an image 75 of five frames backward).

The add/subtract section 525 generates an overdriven output signal fout(N) by adding or subtracting the overdrive value supplied from the overdrive value output section 522 to/from the input image fin(N). The add/subtract section 526 generates a immediately preceding image fbuf1(N+1) for the next frame by adding or subtracting the difference value of the image of the current frame (namely, the immediately preceding frame as viewed from the next frame) supplied from the difference value calculating section 523 to/from the input image fin(N).

The video signal processing section 5, the frame memory section 6, the data driver 34 and the gate driver 33 correspond to specific example of the “driving section” according to the embodiment of the present invention.

Subsequently, operation and effects of the LCD device 1 according to the present embodiment will be hereinafter described.

First, basic operation of the LCD device 1 will be hereinbelow described with reference to FIGS. 1 to 3.

In the LCD device 1, the video signal Din supplied from outside is image-processed with the image processing section 51 so that the input image fin(N) is generated, as illustrated in FIG. 1. Then, the overdrive processing is applied to the input image fin(N) with the overdrive processing section 52 in collaboration with the frame memory section 6 and the memory control section 54, thereby generating the overdriven output image fout(N). The timing control section 53 generates a video signal for the respective pixels 4 based on the output image fout(N) and supplies the video signal to the data driver 34. Thus, display driving is line-sequentially operated to the respective pixels 4 with a driving voltage, which is applied thereto from the gate driver 33 and the data driver 34 based on the video signal supplied in this manner. Specifically, as illustrated in FIGS. 2A and 2B, ON/OFF state of the TFT elements 42A and 42B is switched in response to a selection signal supplied from the gate driver 33 via gate line G, and a conductive state is selectively made between the data lines D1 and D2 and the pixel electrodes 41A and 41B.

Then, in the pixel 4 in which the data lines D1 and D2 and the pixel electrodes 41A and 41B are made conductive, illumination lights from the backlight section 30 are modulated in the LCD panel 2 and outputted as a display light “Lout”, as illustrated in FIG. 3. Thus, image is displayed based on the video signal Din in the LCD device 1.

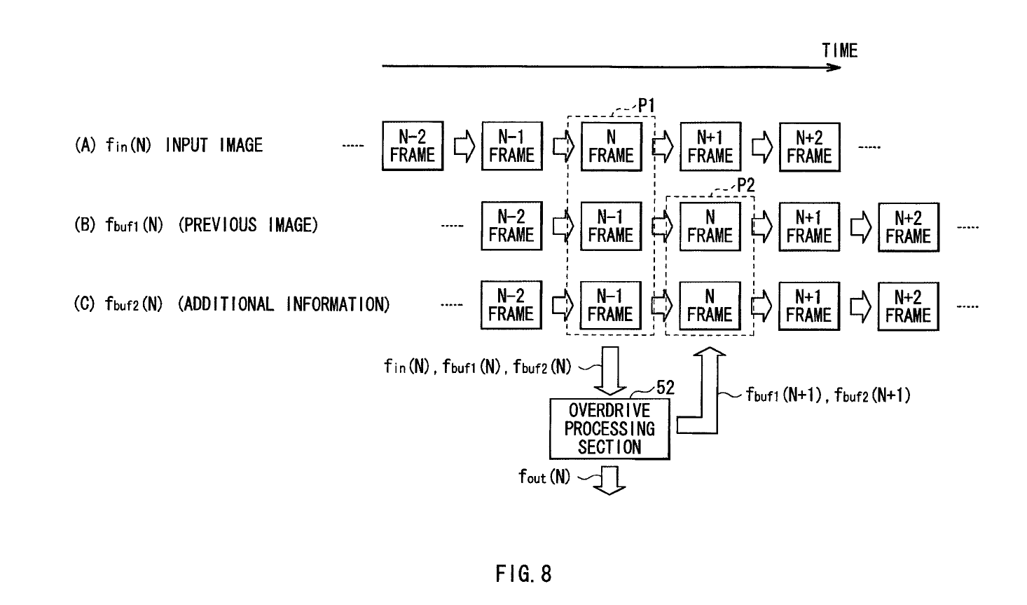

Subsequently, operation and effects of the overdrive processing, which is one of the characteristic portions of the LCD device according to the embodiment of the present invention will be explained in detail with reference to FIGS. 4 to 8 in addition to FIGS. 1 to 3. FIG. 8 are timing diagrams illustrating the overdrive processing according to the present embodiment, and (A) in FIG. 8 represents the input image fin(N), (B) in FIG. 8 represents the immediately preceding image fbuf1(N), and (C) in FIG. 8 represents the additional information fbuf2(N) respectively along the time axis (frame-by-frame time axis).

As illustrated in FIG. 4, in the overdrive processing section 52 of the present embodiment, the current state of the liquid crystal element (effectual voltage holding level) in the current frame is calculated at first in the holding level calculating section 521 based on the immediately preceding image fbuf1(N) and the additional information fbuf2(N). Subsequently, the overdrive value is calculated based on the current state of the liquid crystal element (effectual voltage holding level) in the current frame and the input image fin(N) in the overdrive value computing section 522. Then, the overdriven output signal fout(N) is generated by adding or subtracting the overdrive value to/from the input image fin(N) in the add/subtract section 525.

More specifically, as shown by the reference numeral P1 of FIG. 8 for example, the overdrive processing section 52 generates the overdriven output image fout(N) based on the input image fin(N) in the current frame (the frame “N”), the immediately preceding image fbuf1(N) in the immediately preceding frame (the frame “N−1”) and the additional information fbuf2 corresponding to the immediately preceding frame. At the same time, as shown by the reference numeral P2, the immediately preceding image fbuf1(N+1) and the additional information fbuf2 (N+1) corresponding to the current frame, which are used when applying an overdrive processing to a video signal of an input image fin (N+1) in the next frame (the frame “N+1”), is generated based on the input image fin(N) in the current frame (the frame “N”), the immediately preceding image fbuf1(N) in the immediately preceding frame (the frame “N−1”) and the additional information fbuf2(N) corresponding to the immediately preceding frame.

In this manner, the overdrive processing is performed by generating as needed the additional information 7 and 72 to 75 as illustrated by FIGS. 6, 7A and 7B, for example, and using the additional information 7 and 72 to 75 in the next frame.

In the overdrive processing of the present embodiment, since the additional information fbuf2(N) (7 and 72 to 75) additionally including information of a preceding frame previous to the immediately preceding frame (frame “N−1”) is used, more effective overdrive processing is available than the case in which only the image in the immediately preceding frame is used. Since the additional information fbuf2(N) (7 and 72 to 75) is expressed in brevity, configuration thereof is simplified compared with the case in which the whole image of two or more frames backward is used directly as it is.

As mentioned above, according to the present embodiment, the overdriven video signal (output image fout(N)) is generated by applying the overdrive processing to the video signal of the input image fin(N) based on the input image fin(N) (in the current frame “frame N”), the immediately preceding image fbuf1(N) that is an image in the immediately preceding frame (the frame “N−1”), and the additional information fbuf2(N) that is information expressed in brevity on the state of the liquid crystal elements of the respective pixels 4 in the immediately preceding frame. Accordingly, more effective overdrive processing as well as more simple configuration than ever is available because of the usage of the additional information fbuf2(N) (7 and 72 to 75) in which information of preceding frames previous to the immediately preceding frame (the frame “N−1”) is expressed in brevity. As a result, it becomes possible to improve the response time with simpler configuration than ever.

Specifically, since the compressed information formed by compressing images of two or more frames backward from the current frame (here, the image 72 of two frames backward to the image 74 of four frames backward) is used as the additional information, the above-mentioned effects are available.

What is more, when such information is formed by weighting the amount of information (bits) such that it is getting smaller as frames go backward, it becomes possible to include more previous information than ever. As a result, more effective overdrive processing is available and response time can be improved.

### (Modification)

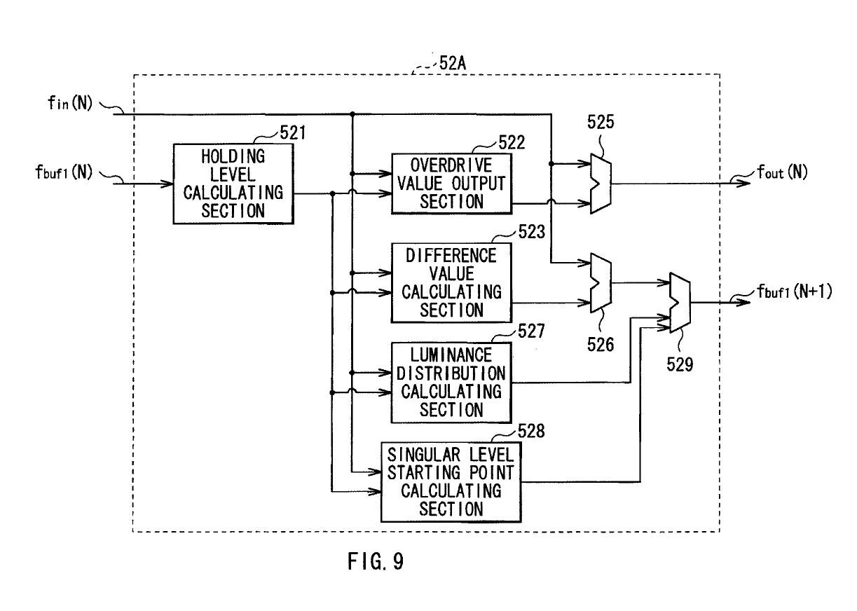

FIG. 9 illustrates a block configuration of an overdrive processing section (overdrive processing section 52A) according to a modification of the present invention. Here, the Same Reference Numerals as in the Above Embodiment have been used to indicate substantially identical components, and descriptions will be appropriately omitted.

The overdrive processing section 52A according to the present modification includes the holding level calculating section 521, the overdrive value output section 522, the difference value calculating section 523, a luminance distribution computing section 527, a singular level starting point calculating section 528, the add/subtract sections 525 and 526, and a combining section 529. Namely, the overdrive processing section 52A is configured such that the luminance distribution computing section 527 and the singular level starting point calculating section 528 substitute for the additional information calculating section 524 provided in the overdrive processing section 52 according to the above-mentioned embodiment are provided, and additionally includes the combining section 529.

The luminance distribution computing section 527 calculates distribution of the luminance in the pixel 4 over the images of the preceding and subsequent frames based on the current state of the liquid crystal element (effectual voltage holding level) in the current frame supplied from the holding level calculating section 521 and the input image fin(N).

The singular level starting point calculating section 528 detects a value representing which one of the preceding frames is responsible for a singular response of the liquid crystal using an LUT (not illustrated) based on the current state of the liquid crystal element (effectual voltage holding level) in the current frame supplied from the holding level calculating section 521 and the input image fin(N), and then decrements the value. The result is outputted as a flag count value 77.

The combining section 529 generates a immediately preceding image fbuf1(N+1) as viewed from the next frame based on an output value from the add/subtract section 526, the distribution of luminance in the pixel 4 over the images of backward and forward frames supplied from the luminance distribution computing section 527, and the information about which one of the preceding frames is the factor of the singular response of the liquid crystal (what is called flag count value 77) supplied from the singular level starting point calculating section 528.

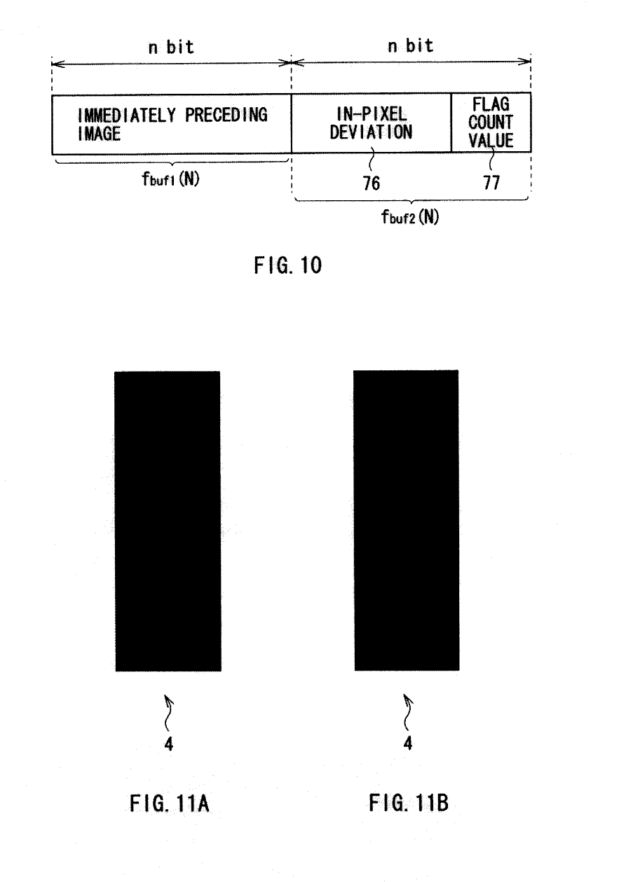

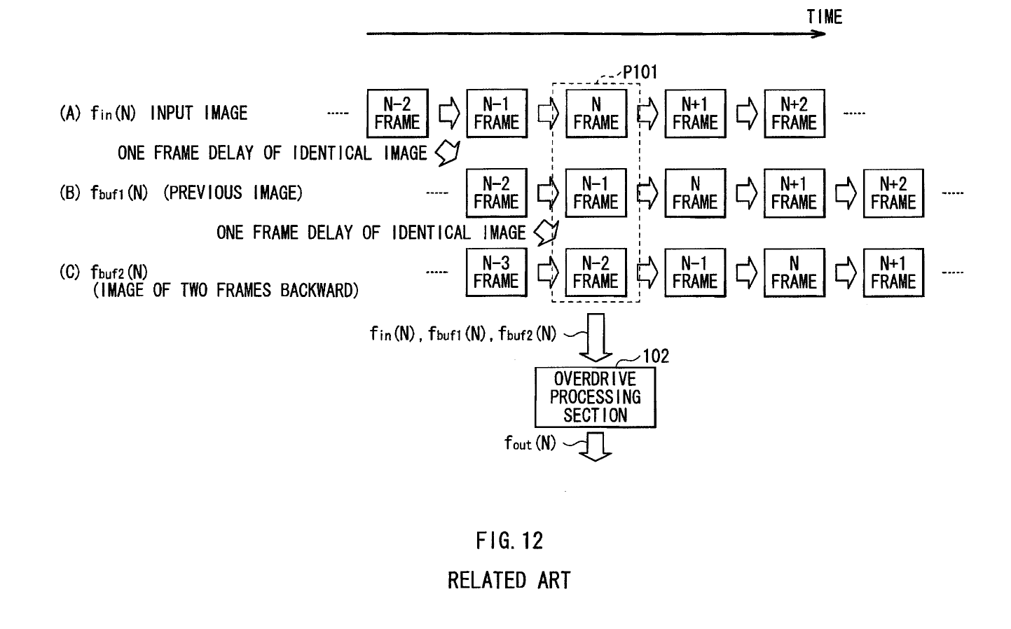

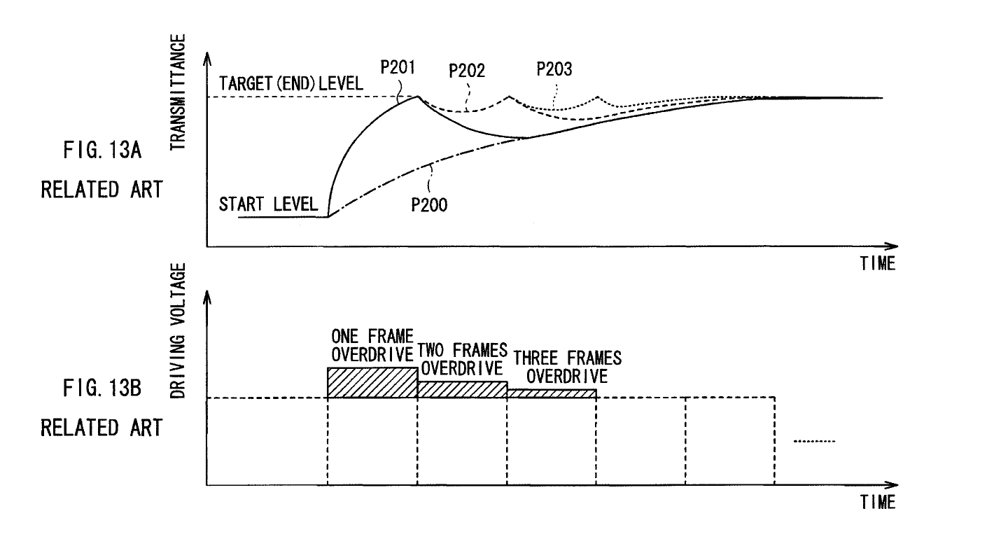

With such a configuration, according to the present modification, the overdrive processing section 52A carries out the overdrive processing using, as illustrated in FIG. 10 for example, an in-pixel deviation 76 representing the deviation of the liquid crystal state within a pixel (corresponding to distribution of luminance in the pixel 4 over the images of backward and forward frames, which is supplied from the luminance distribution computing section 527) and a flag count value 77 representing which one of preceding frames is the factor of a singular response of the liquid crystal (corresponding to the data supplied from the singular level starting point calculating section 528).

The in-pixel deviation 76 appears in such a manner as illustrated by the photo diagram of FIGS. 11A and 11B for example, which are images of a pixel in the halftone gradation. These figures are based on a video signal of the same luminance gradation, and FIG. 11A indicates a state in which the pixel 4 is in the course of response while FIG. 11B indicates a state of stable response in which enough time has already passed. It is to be noted that even when the luminance gradation is equivalent, some mode of liquid crystal may have a different transmittance (luminance) depending on the state of response distribution. It is found that in FIG. 11A, luminance is earned by the area of quicker response within the pixel 4 to try to attain the same luminance as that of FIG. 11B in total.

As mentioned above, in the present modification, since an overdriven video signal (output image fout(N)) is generated by applying the overdrive processing to the video signal of the input image fin(N) based on the input image fin(N), the immediately preceding image fbuf1(N) and the additional information fbuf2(N), effects similar to the above-mentioned embodiment are available due to the operation similar thereto. Namely, improvement in response time with simpler configuration than ever is available.

Specifically, since the in-pixel deviation 76 representing the deviation of the liquid crystal state in a pixel and the flag count value 77 representing which one of preceding frames is the factor of the singular response of the liquid crystal are used as the additional information, the above-mentioned effects become available.

Although the present invention has been described above with reference to the embodiment and modification, the invention is not limited to the embodiment and modification but may be variously modified.

For example, configuration of the look-up table (LUT) and additional information is not limited to those illustrated in FIGS. 5, 7A, 7B and 10, and any other configuration is available.

The configuration of the pixel and LCD panel is not limited to those illustrated in FIGS. 2A, 2B and 3, and other configuration is available.

In addition, although description is made about the VA-mode liquid crystal in the above-mentioned embodiment or the like, the invention may also be applied for example, to liquid crystals in other modes, such as TN (twisted nematic) mode and IPS (in-plane switching) mode.

The present application contains subject matter related to that disclosed in Japanese Priority Patent Application JP 2008-212997 filed in the Japan Patent Office on Aug. 21, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid crystal display device comprising:
a plurality of pixels each including a liquid crystal element therein; and
a driving section performing an image display driving by applying a driving voltage based on a video signal to the liquid crystal element in each of the pixels,
wherein the driving section performs an overdrive processing on the video signal of current frame to generate an overdriven video signal based on a current frame image and an immediately preceding frame image of the input images based on the video signals, and based on immediately-preceding-state information which is additional information briefly representing a immediately preceding state of the liquid crystal element of the pixel.

2. The liquid crystal display device according to claim 1, wherein the display driving section generates current state information, which is additional information briefly representing a current state of the liquid crystal element and is to be used in the overdrive processing on the video signal of following frame, based on the current frame image, the immediately preceding frame image and the immediately-preceding-state information.

3. The LCD device according to claim 1, wherein the driving section uses compressed information as the preceding state information, the compressed information being formed through compressing images of frames preceding the current frame by two or more frames.

4. The LCD device according to claim 3, wherein the compressed information is configured to include a plurality of information pieces each formed through compressing an image of each of preceding frames, the information piece being weighted in its information amount so that the information amount of the information piece decreases as going backward from the current frame.

5. The liquid crystal display device according to claim 1, wherein the preceding state information is configured to include an in-pixel deviation and a flag counter value, the in-pixel deviation representing a deviation of a liquid crystal state within a pixel, and the flag counter value representing which one of preceding frames is responsible for singular response of the liquid crystal.

6. The LCD device according to claim 1, wherein the liquid crystal element is configured to include the vertical alignment mode (VA-mode) liquid crystal.
